(19) United States
(12) Patent Application Publication
(10) Pub. No.: US 2005/0248583 A1
(43) Pub. Date: Nov. 10, 2005

(54) Dither processing circuit of display apparatus

(75) Inventor: Akira Gotoda, Nakakoma-gun (JP)

Correspondence Address: SUGHRUE MION, PLLC, 2100 PENNSYLVANIA AVENUE, N.W., SUITE 800, WASHINGTON, DC, 20037, US

(73) Assignee: PIONEER CORPORATION

(21) Appl. No.: 11/121,924

(22) Filed: May 5, 2005

(30) Foreign Application Priority Data
May 6, 2004 (JP) 2004-137275

(51) Int. Cl. G09G 5/02

(52) U.S. Cl. 345/596

(57) ABSTRACT

A dither processing circuit of a display apparatus including a dither value generator for generating a dither value correspondingly to each pixel position for each pixel group in a frame, and an adder for adding the dither value to pixel data for each pixel of each pixel group to output the added result as dither processing pixel data, wherein the dither value generator changes the dither value to be generated, in accordance with movement of an image which the video signal indicates.

### BACKGROUND OF THE INVENTION

1. Field of the Invention

The present invention relates to a dither processing circuit that improves gradation display of a display apparatus

2. Description of the Related Art

Recently, as a two-dimensional image display panel that is a thin type and lightweight, a plasma display panel (hereinafter referred to as a PDP) has received attention. The PDP is directly driven by a digital video signal, and gray scale of luminance which the PDP can represent is determined by bit number of pixel data of each pixel on the basis of the above digital video signal.

As a method of gradation-driving the PDP, a subfield method has been known, in which a unit frame display period, for example, one field (one frame) display period is divided into subfields of N-number, of which each emits light for only time corresponding to a weight of each bit digit of pixel data (N bits), thereby to drive the PDP. Herein, the field takes a video signal of interlaced type such as NTSC into consideration, and in a video signal of non-interlaced type, the field corresponds to a frame.

For example, in the case that pixel data is 8 bits, one filed display period is divided into 8 subfields comprising subfields SF8, SF7, . . . , SF1 in order of a weight. Each of the subfields has an address period in which setting of a lit pixel and a unlit pixel according to pixel data is performed for each display line of the PDP, and a sustain period in which only the lit pixel is caused to emit light for only time corresponding to a weight of its subfield. Namely, in each of the subfields, light-emission drive control determining whether light emission is executed or not in its subfield is individually performed. Therefore, in one field, subfields in a “light emission state” and subfields in a “non-light emission state” are mixed. At this time, by total time of light emission executed in each subfield in one filed, a halftone luminance is represented.

In a display apparatus adopting the PDP, the gradation drive uses dither processing together, thereby to increase the gray scale visually and improve image quality.

In the dither processing, by a plurality of pixels on a display screen which are adjacent to each other, one halftone luminance is represented. For example, with four pixels adjacent to each other up and down and right and left forming a set, four dither values (for example, 0, 1, 2, and 3) composed of values (added value) different to each other are assigned to pixel data corresponding to each of this set of pixels, and added to each pixel data.

As described above, an image to which the dither processing has been applied, when the image is a static image, is not different from an original image because of a visual integral effect, so that the image of high quality can be seen. However, in the case that the image to which dither processing has been applied is a dynamic image, since user's eyes move with movement of the image, there is a problem that noise (pattern) peculiar to the dither processing becomes prominent readily.

### SUMMARY OF THE INVENTION

An object of the invention is to provide a dither processing circuit of a display apparatus which can perform good dither processing by which noise in a dynamic image is suppressed.

A dither processing circuit according to the invention is a dither processing circuit of a display apparatus for displaying a two-dimensional image on a display screen in accordance with a video signal indicative of pixel data for each pixel of a frame, comprising: a dither value generator which generates a dither value correspondingly to each pixel position for each pixel group in the frame; and an adder which adds the dither value to pixel data for each pixel of each pixel group to output the added result as dither processing pixel data, wherein the dither value generator changes the dither value to be generated, in accordance with movement of an image which the video signal indicates.

### BRIEF DESCRIPTION OF THE DRAWINGS

FIG. 1 is a diagram showing the general configuration of a plasma display apparatus on which a dither processing circuit according to the invention is mounted;

FIG. 2 is a diagram showing the inner constitution of a data conversion circuit;

FIG. 3 is a diagram showing the inner constitution of an ABL circuit;

FIG. 4 is a diagram showing conversion characteristic in the data conversion circuit;

FIG. 5 is a diagram showing data conversion characteristic in a first data conversion circuit;

FIG. 6 is a diagram showing a conversion table of a second data conversion circuit and a light emission drive pattern;

FIG. 7 is a diagram showing a light emission drive format of the plasma display apparatus shown in FIG. 1;

FIG. 8 is a diagram showing application timing at which various drive pulses are applied to a PDP in one filed display period;

FIG. 9 is a diagram showing the inner constitution of a multi gradation processing circuit;

FIG. 10 is a diagram for explaining an operation of an error diffusion processing circuit;

FIG. 11 is a diagram showing the inner constitution of a dither processing circuit;

FIG. 12 is a diagram showing correspondence of each pixel G in the PDP and a pixel group of 4 rows×4 columns;

FIGS. 13A to 13D are diagrams showing a static image dither table, lower three-bit data of input pixel data ED of 4 rows×4 columns, an added result, and its output average;

FIGS. 14A to 14C are diagrams showing a dynamic image dither table, lower three-bit data of input pixel data ED of 4 rows×4 columns, an added result, and its output average;

FIG. 15 is a diagram showing another inner constitution of the dither processing circuit;

FIGS. 16A to 16C are diagrams showing a dither table, dither value groups after random conversion, lower three-bit data of input pixel data ED of 4 rows×4 columns, an added result, and its output average;

FIG. 17 is a diagram showing another inner constitution of the dither processing circuit; and

FIG. 18 is a diagram showing the inner constitution of a movement detecting circuit.

### DETAILED DESCRIPTION OF THE INVENTION

An embodiment of the invention will be described below in detail with reference to drawings.

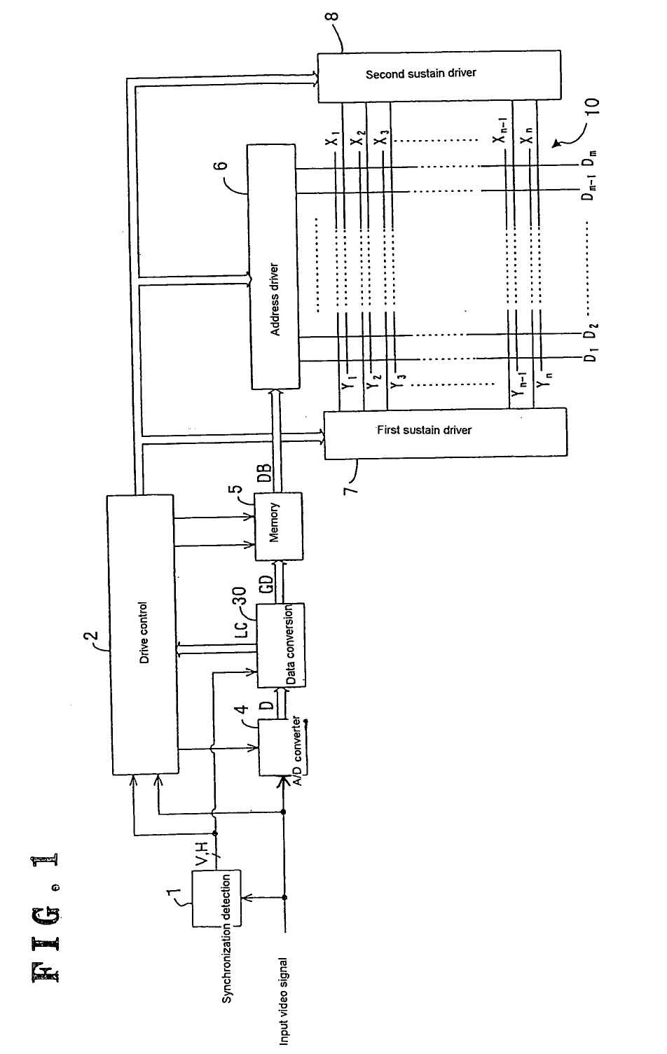

FIG. 1 shows the general configuration of a plasma display apparatus on which a dither processing circuit according to the invention is mounted.

The plasma display apparatus comprises a PDP 10 as a plasma display panel, and a drive part (a synchronization detecting circuit 1, a drive control circuit 2, an A/D converter 4, a data conversion circuit 30, a memory 5, an address driver 6, a first sustain driver 7, and a second sustain driver 8) which drives this plasma display panel.

The PDP 10 includes column electrodes D₁ to Dₘ as address electrodes, and row electrodes X₁ to Xₙ and Y₁ to Yₙ which are arranged orthogonal to these column electrodes. In the PDP 10, a pair of the row electrode X and the row electrode Y forms a row electrode corresponding to one line. The row electrode pair and the column electrode are coated with a dielectric layer in discharge space, and a discharge cell corresponding to a pixel is formed at the intersection of each row electrode pair with each column electrode. Namely, in the PDP 10, n×m pixels respectively corresponding to (the first row·the first column)−(the n-th row·the m-th column) are formed.

The synchronization detecting circuit 1, when detects a vertical synchronization signal from a video signal as a unit frame data signal supplied continuously for each frame, generates a vertical synchronization signal V. Further, the synchronization detecting circuit 1, when detecting a horizontal synchronization signal from the video signal, generates a horizontal synchronization signal H. The synchronization detecting circuit 1 supplies each of these vertical synchronization signal V and horizontal synchronization signal H to the drive control circuit 2 and the data conversion circuit 30. The A/D converter 4 samples the video signal in accordance with a clock signal supplied from the drive control circuit 2, converts this video signal into pixel data D of each pixel, for example, 8-bit pixel data D, and supplies the pixel data to the data conversion circuit 30.

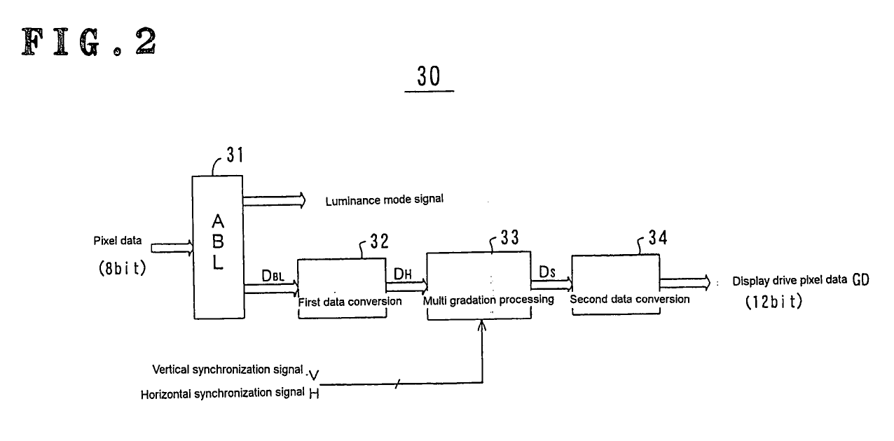

FIG. 2 is a diagram showing the inner constitution of the data conversion circuit 30.

As shown in FIG. 2, the data conversion circuit 30 comprises an ABL (automatic luminance control) circuit 31, a first data conversion circuit 32, a multi gradation processing circuit 33, and a second data conversion circuit 34.

The ABL circuit 31 adjusts a luminance level of the pixel data D of each pixel supplied sequentially from the A/D converter 4 so that the average luminance of an image displayed on a screen of the PDP 10 can be accommodated in an appropriate luminance range, and supplies a luminance adjustment pixel data D_{BL} obtained at this time to the first data conversion circuit 32.

FIG. 3 is a diagram showing the inner constitution of the ABL circuit 31.

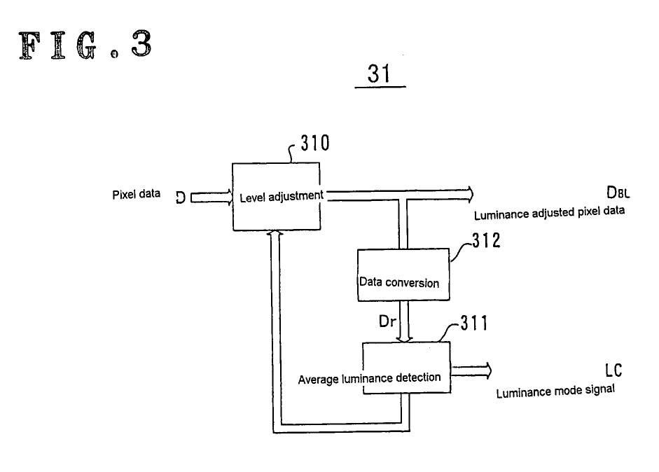

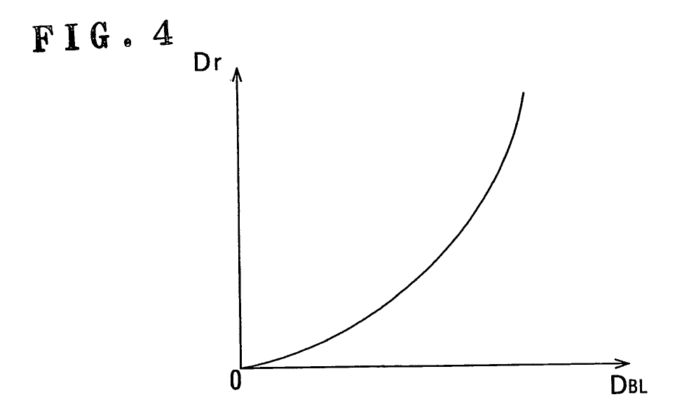

In FIG. 3, a level adjusting circuit 310 output luminance adjusted pixel data D_{BL} obtained by adjusting the luminance level of the pixel data D in accordance with the average luminance obtained by an average luminance detecting circuit 311 described later. A data conversion circuit 312 converts the luminance adjusted pixel data D_{BL} into data having inverse gamma characteristic (Y=X^{2.2}) composed of non-linear characteristic as shown in FIG. 4, and supplies the converted data to the average luminance level detecting circuit 311 as inverse gamma conversion pixel data Dr. Namely, by providing inverse gamma correction for the luminance adjusted pixel data D_{BL}, pixel data (inverse gamma conversion pixel data Dr) corresponding to an original video signal in which gamma correction has been released is restored. The average luminance detecting circuit 311 firstly finds the average luminance of the inverse gamma conversion pixel data Dr. Here, the average luminance detecting circuit 311 judges which of luminance modes 1-4 obtained by classifying a range of max luminance to minimum luminance into four stages the average luminance corresponds to, supplies a luminance mode signal LC representing this corresponding luminance mode to the drive control circuit 2, and supplies the above-obtained average luminance to the level adjusting circuit 310. Namely, the level adjusting circuit 310 supplies the pixel data D of which the luminance level has been adjusted in accordance with the average luminance, as the luminance adjusted pixel data D_{BL}, to the data conversion circuit 312 and the first data conversion circuit 32 of the next stage. The first data conversion circuit 32 converts the luminance adjusted pixel data D_{BL}, on the basis of conversion characteristic shown in FIG. 5, into first conversion pixel data D_{H} of 9-bit of “0” to “384”, and supplies this first conversion pixel data D_{H} to the multi gradation processing circuit 33. By the first data conversion circuit 32, data conversion is conducted according to the display gray scale in the multi gradation processing circuit 33 which will be described below and the compressed bit number by multi gradation processing. Namely, luminance saturation in multi gradation processing by the multi gradation processing circuit 33, and occurrence of the display characteristic at a flat portion (i.e., occurrence of gradation distortion) produced in the case that the display gradation does not exist in a bit boundary are prevented.

The multi gradation processing circuit 33 provides the error diffusion processing and the dither processing for the 9-bit first conversion pixel data D_{H} thereby to generate multi gradation processing pixel data D_{S} in which the bit number is reduced to 4 bits with the present gray scale kept. These error diffusion processing and dither processing will be described later. The second data conversion circuit 34 converts the 4-bit multi gradation processing pixel data D_{S} into display drive pixel data GD of the first to the twelfth bits in accordance with a conversion table shown in FIG. 6. Further, these first to twelfth bits respectively corresponds to subfields SF1 to SF12 described later.

Thus, according to the multi gradation processing circuit 33 and the second data conversion circuit 34, the 8-bit pixel data D capable of representing 256 gradations is converted into the 12-bit display drive pixel data GD of 13 patterns as shown in FIG. 6.

The memory 5 writes and stores, in accordance with a writing signal supplied from the drive control circuit 2, the display drive pixel data GD sequentially. When writing of the display drive pixel data GD₁₁₋ₙₘ of one frame (n rows, m columns) is completed by the writing operation, the memory 5, in accordance with a reading signal supplied from the drive control circuit 2, reads sequentially the display drive pixel data GD₁₁₋ₙₘ of the same bit digit for each row, and supplies the data GD₁₁₋ₙₘ to the address driver 6. Namely, the memory 5 takes the 12-bit display drive pixel data GD₁₁₋ₙₘ of one frame as display drive pixel data DB1₁₁₋ₙₘ to DB12₁₁₋ₙₘ divided into 12 as follows:
DB1₁₁₋ₙₘ: the first bit of display drive pixel data GD₁₁₋ₙₘ
DB2₁₁₋ₙₘ: the second bit of display drive pixel data GD₁₁₋ₙₘ
DB3₁₁₋ₙₘ: the third bit of display drive pixel data GD₁₁₋ₙₘ
DB4₁₁₋ₙₘ: the fourth bit of display drive pixel data GD₁₁₋ₙₘ
DB5₁₁₋ₙₘ: the fifth bit of display drive pixel data GD₁₁₋ₙₘ
DB6₁₁₋ₙₘ: the sixth bit of display drive pixel data GD₁₁₋ₙₘ
DB7₁₁₋ₙₘ: the seventh bit of display drive pixel data GD₁₁₋ₙₘ
DB8₁₁₋ₙₘ: the eighth bit of display drive pixel data GD₁₁₋ₙₘ
DB9₁₁₋ₙₘ : the ninth bit of display drive pixel data GD₁₁₋ₙₘ
DB10₁₁₋ₙₘ: the tenth bit of display drive pixel data GD₁₁₋ₙₘ
DB11₁₁₋ₙₘ: the eleventh bit of display drive pixel data GD₁₁₋ₙₘ
DB12₁₁₋ₙₘ: the twelfth bit of display drive pixel data GD₁₁₋ₙₘ

Next, the memory 5 reads sequentially each of these DB1₁₁₋ₙₘ, DB2₁₁₋ₙₘ, . . . , and DB12₁₁₋ₙₘ every one row in accordance with the reading signal supplied from the drive control circuit 2 to supply this to the address driver 6.

The drive control circuit 2 generates a clock signal for the A/D converter 4 and a writing/reading signal for the memory 5 in synchronization with the horizontal synchronization signal H and the vertical synchronization signal V.

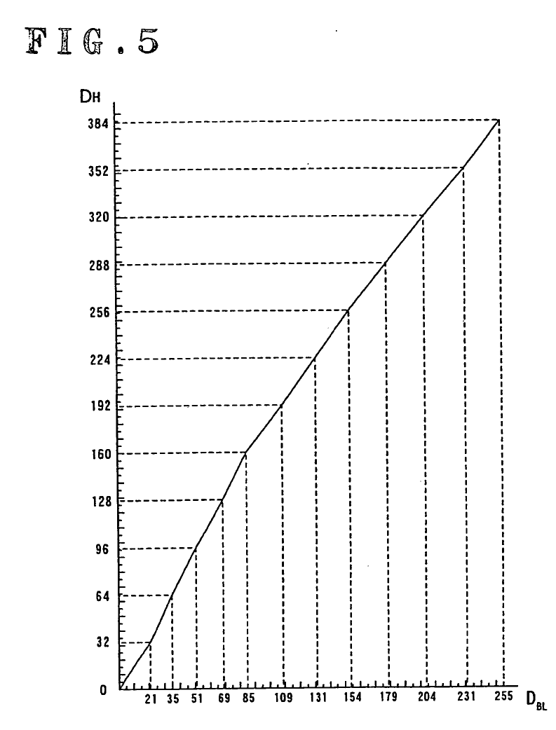

Further, the drive control circuit 2 supplies, in accordance with a light emission drive format shown in FIG. 7, various timing signals to drive the PDP 10 to each of the address driver 6, the first sustain driver 7 and the second sustain driver 8.

In the light emission drive format shown in FIG. 7, a unit frame display period, so-called one field period is divided into 12 subfields SF1 to SF12. In each subfield, a pixel data writing step Wc in which pixel data is written into each discharge cell of the PDP 10 thereby to set “a light emission cell” and “a non-light emission cell”, and a light emission sustaining step Ic in which only the “light emission cell” is caused to emit light for only the period (by a number of times) corresponding to a weight of each subfield are executed. However, only in the first subfield SF1, a simultaneous reset step Rc in which all the discharge cells of the PDP 10 are initialized is executed, and only in the last subfield SF12, an erasure step E is executed.

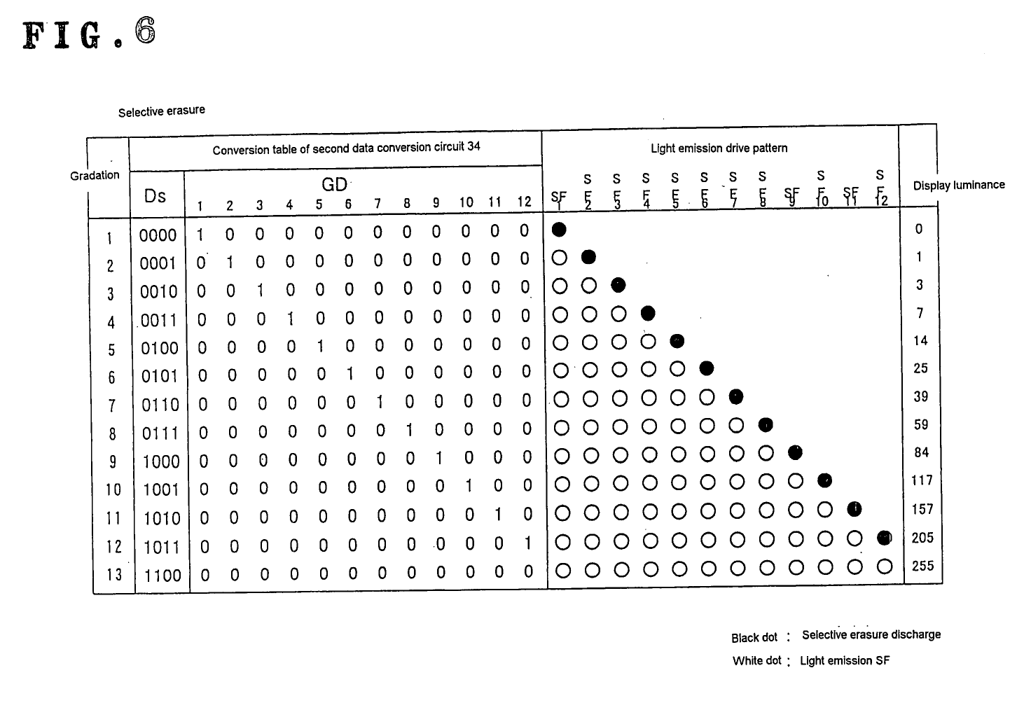

FIG. 8 is a diagram showing application timing at which each of the address driver 6, the first sustain driver 7 and the second sustain driver 8 applies various drive pulses to the row electrode and the column electrode of the PDP.

Firstly, in the simultaneous reset step Rc in the subfield SF1, the first sustain driver 7 applies a reset pulse RP_{X} of negative polarity as shown in FIG. 8 to the row electrodes X₁ to Xₙ. Simultaneously with the application of the reset pulse RP_{X}, the second sustain driver 8 applies a reset pulse RP_{y} of positive polarity as shown in FIG. 8 to the row electrodes Y₁ to Y₂. In accordance with the application of these reset pulses RP_{X} and PR_{Y}, all the discharge cells in the PDP 10 are reset-discharged, and the predetermined amount of wall charges are uniformly formed in each discharge cell. Hereby, all the discharge cells are once set “light emission cells”.

Next, in the pixel data writing step Wc in each subfield, the address driver 6 generates a pixel data pulse having a voltage corresponding to the logical level of the display drive pixel data bit DB supplied from the memory 5. At this time, the address driver 6 applies a pixel data pulse group DP composed of pixel data pulses corresponding to one line to the column electrode D₁₋ₘ. For example, in the pixel data writing step Wc of the subfield SF1, the address driver 6 extracts, from the display drive pixel data bit DB1₁₁₋ₙₘ, the data corresponding to the first line, that is, DB1₁₁₋₁ₘ, generates a pixel data pulse group DP1₁ composed of m pixel data pulses corresponding to the logical level of each of these DB1₁₁₋₁ₘ, and applies the pixel data pulse group DP1₁ to the column electrode D₁₋ₘ. Next, the address driver 6 extracts, from the display drive pixel data bit DB1₁₁₋ₙₘ, the data corresponding to the second line, that is, DB1₂₁₋₂ₘ, generates a pixel data pulse group DP1₂ composed of m pixel data pulses corresponding to the logical level of each of these DB1₂₁₋₂ₘ, and applies the pixel data pulse group DP1₂ to the column electrode D₁₋ₘ. Hereinafter, similarly, in the pixel data writing step Wc of the subfield SF1, pixel data pulse groups DP1₃ to DP1ₙ are sequentially applied to the column electrode D₁₋ₘ. Further, the address driver 6, in the case that the logical level of the display drive pixel data bit DB is “1”, generates a pixel data pulse which is at high voltage, and in the case that the logical level of the display drive pixel data bit DB is “0”, the address driver 6 generates a pixel data pulse which is at low voltage (zero volt).

Further, in the pixel data writing step Wc, the second sustain driver 8 generates a scanning pulse SP of negative polarity as shown in FIG. 8 at the same timing as the timing at which each of the data pulse groups DP is applied, and sequentially applies this to the row electrodes Y₁ to Yₙ. At this time, a discharge (selective erasure discharge) occurs only in discharge cells at intersections of the “rows” to which the scanning pulse SP has been applied and the “columns” to which the pixel data pulse at high voltage has been applied to erase wall charges remaining in these discharge cells selectively. Namely, each of the first bit to the twelfth bit in the display drive pixel data GD determines whether the selective erasure discharge is caused in the pixel data writing step Wc of each of the subfields SF1 to SF12. By the selective erasure discharge, the discharge cells, which have been initialized to the “light emission cell” state in the simultaneous reset step Rc, proceed to an “non-light emission cell” state. On the other hand, a discharge does not occur in discharge cells formed in the “columns” to which the pixel data pulse at low voltage has been applied, and their discharge cells remain in the present state. Namely, the discharge cell in the “non-light emission cell” state remains in the “non-light emission cell” state, and the discharge cell in the “light emission cell” state remains in the “light emission cell” state. Thus, by the pixel data writing step Wc of each subfield, the “light emission cell” in which a sustain discharge is caused in a light emission sustain step IC immediately after the step Wc and the “non-light emission cell” in which the sustain discharge is not caused are set.

Next, in the light emission sustain step Ic of each subfield, each of the first sustain driver 7 and the second sustain driver 8 applies sustain pulses IP_{X} and IP_{Y} of positive polarity alternately to the row electrodes X₁ to Xₙ and Y₁ to Yₙ as shown in FIG. 8.

Here, the number of times the sustain pulse IP is applied in the light emission sustain step Ic of each subfield SF1 to SF12 is as follows: SF1: 1, SF2: 2, SF3: 4, SF4: 7, SF5: 11, SF6: 14, SF7: 20, SF8: 25, SF9: 33, SF10: 40, SF11: 48, and SF12: 50.

In only the last subfield SF12, the erasure step E is executed.

In the erasure step E, the address driver 6 generates an erasure pulse AP of positive polarity as shown in FIG. 8 and applies this to the column electrode D₁₋ₘ. Further, the second sustain driver 8 generates an erasure pulse EP of negative polarity as shown in FIG. 8 simultaneously with the application timing of the erasure pulse AP, and applies this erasure pulse EP to each of the row electrodes Y₁ to Yₙ. By the simultaneous application of these erasure pulses AP and EP, an erasure discharge is caused in all the discharge cells in the PDP 10, the wall discharges remaining in all the discharge cells are extinguished. Namely, by the erasure discharge, all the discharge cells in the PDP 10 become the “non-light emission cells”.

As described above, in accordance with the light emission drive shown in FIGS. 7 and 8, only the discharge cells which have been set the “light emission cells” in the pixel data writing step Wc of each subfield repeat the light emission in the light emission sustain step Ic immediately after its step Wc by the number of times described above. At this time, by the total number of light emission executed in each subfield SF1 to SF12 in one field, the halftone luminance is represented.

Here, “light emission cell” setting or “non-light emission cell” setting of each discharge cell is determined by the display drive pixel data GD shown in FIG. 6. Namely, in the case that the logical level of each bit of the display drive pixel data GD is “1”, the selective erasure discharge is caused in the pixel data writing step Wc of the subfield corresponding to bit digit of its bit, and the discharge cell is set the “non-light emission cell”. On the other, in the case that the logical level of its bit is “0”, since the selective erasure discharge is not caused, the discharge cell remains in the present state. Namely, the discharge cell in the “non-light emission cell” state remains in the “non-light emission cell” state, and the discharge cell in the “light emission cell” state remains in the “light emission cell” state. At this time, in the subfields SF1 to SF12, an opportunity when the discharge cell in the “non-light emission cell” state can be caused to proceed to the “light emission cell” state is in only the reset step Rc of the first subfield SF1. Namely, after completion of this reset step Rc, the discharge cell, which has once proceeded to the “non-light emission cell” state in the pixel data writing step Wc of any one of the subfields SF1 to SF12 does not proceed again to the “light emission cell” state in this one field. Therefore, according to the display drive pixel data GD shown in FIG. 6, each discharge cell, during a period till the selective erasure discharge is caused in the subfield shown by a black dot in the figure, becomes the “light emission cell”. In the light emission sustain step Ic of each of the subfields shown by white dots existing for that period, the light emission is performed by the number of times as described above.

Therefore, according to the display drive pixel data GD having 13 kinds of data patterns as shown in FIG. 6, gradation drive capable of representing the following luminance of 13 gradations is performed.
[0:1:3:7:14:25:39:59:84:117:157:205:255]

However, the pixel data D obtained on the basis of the above video signal can represent halftone of 8 bits, that is, 256 stages. Therefore, the multi gradation processing is executed by the multi gradation processing circuit 33 so that the halftone display in the vicinity of 256 gradations can be realized in a pseudo manner also by the above gradation drive of 13 stages.

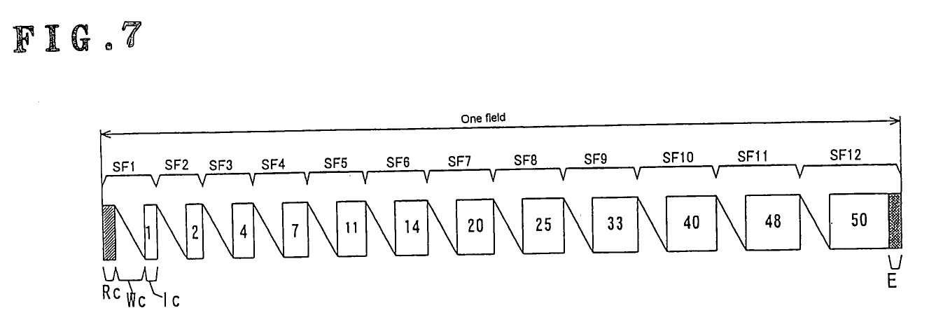

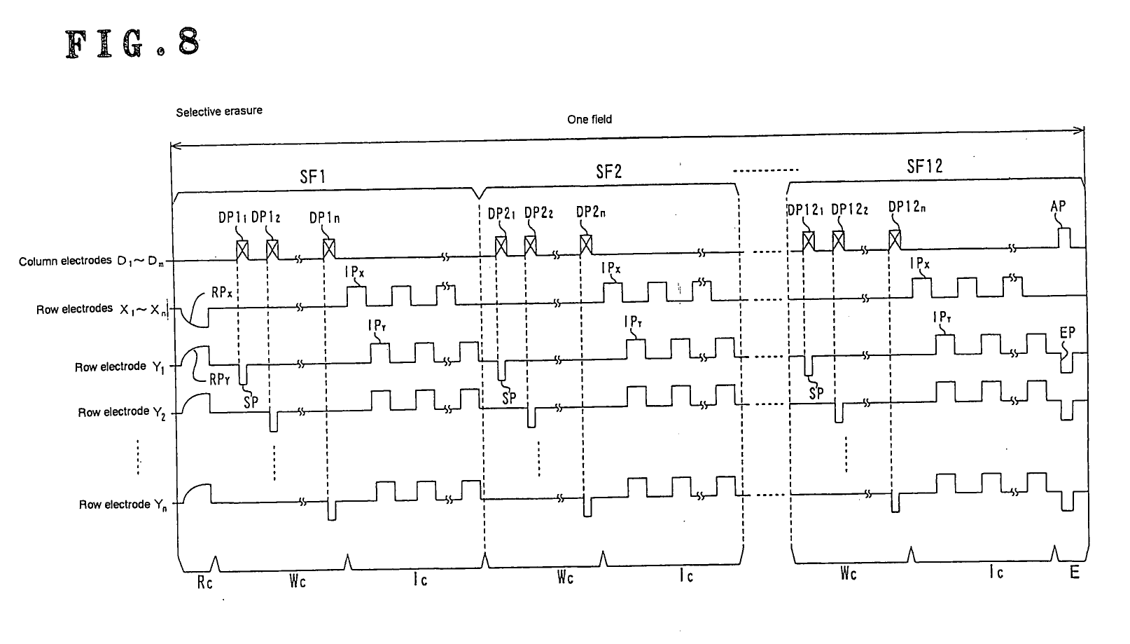

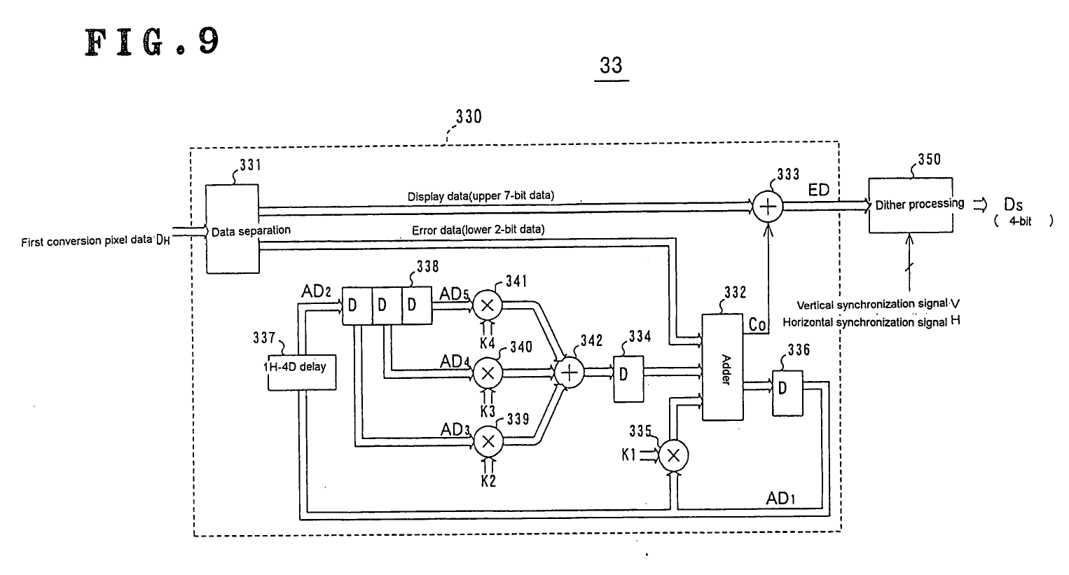

FIG. 9 is a diagram showing the inner constitution of the multi gradation processing circuit 33.

As shown in FIG. 9, the multi gradation processing circuit 33 comprises an error diffusion processing circuit 330 and a dither processing circuit 350.

Firstly, a data separation circuit 331 in the error diffusion processing circuit 330 separates, from the 9-bit first conversion pixel data D_{H} supplied from the first data conversion circuit 32, the upper 7-bit data as display data, and the lower 2-bit data as error data. An adder 332 supplies an added value obtained by adding the lower 2-bit data as the error data in the first conversion pixel data D_{H}, delay output from a delay circuit 334, and multiplication output of a coefficient multiplier 335 to a delay circuit 336. The delay circuit 336 delays the added value supplied from the adder 332 by delay time D having the same time as the clock period in the pixel data A/D converter 4, and supplies this as a delay added signal AD₁ to the coefficient multiplier 335 and a delay circuit 337. The coefficient multiplier 335 supplies a multiplication result obtained by multiplying the delay added signal AD₁ by the predetermined coefficient K₁ (for example, “ 7/16”) to the adder 332. The delay circuit 337 supplies a result obtained by further delaying the delay added signal AD₁ by time represented by (one horizontal scanning period−the delay time D×4) to a delay circuit 338 as a delay added signal AD₂. The delay circuit 338 supplies a result obtained by further delaying the delay added signal AD₂ by the delay time D to a coefficient multiplier 339 as a delay added signal AD₃. Further, the delay circuit 338 supplies a result obtained by further delaying the delay added signal AD₂ by the time represented by the delay time D×2 to a coefficient multiplier 340 as a delay added signal AD₄. Further, the delay circuit 338 supplies a result obtained by further delaying the delay added signal AD₂ by the time represented by the delay time D×3 to a coefficient multiplier 341 as a delay added signal AD₅. The coefficient multiplier 339 supplies a multiplication result obtained by multiplying the delay added signal AD₃ by the predetermined coefficient K₂ (for example, “ 3/16”) to an adder 342. The coefficient multiplier 340 supplies a multiplication result obtained by multiplying the delay added signal AD₄ by the predetermined coefficient K₃ (for example, “ 5/16”) to the adder 342. The coefficient multiplier 341 supplies a multiplication result obtained by multiplying the delay added signal AD₅ by the predetermined coefficient K₄ (for example, “ 1/16”) to the adder 342. The adder 342 supplies an added signal obtained by adding the multiplication results supplied from the coefficient multipliers 339, 340 and 341 to the delay circuit 334. The delay circuit 334 delays the added signal by the time comprising the delay time D to supply this to the adder 332. The adder 332 adds the error data (lower 2-bit data in the first conversion pixel data D_{H}), the delay output from the delay circuit 334, and the multiplication output of the coefficient multiplier 335. In the case that there is not carry, the adder 332 generates a carry out signal Cₒ of logical level “0” to supply its signal to an adder 333, and in the case that there is carry, the adder 332 generates a carry out signal Cₒ of logical level “1” to supply its signal to the adder 333. The adder 333 outputs data obtained by adding the carry out signal Cₒ to the above display data (upper 7-bit data in the first conversion pixel data D_{H}) as 7-bit error diffusion processing pixel data ED.

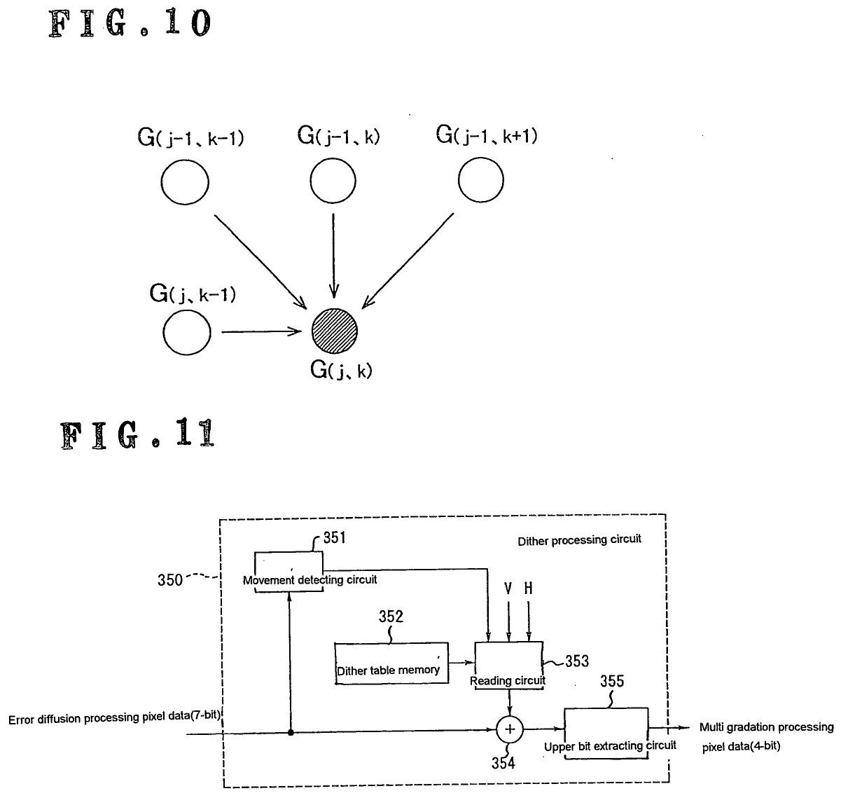

The operation of the error diffusion processing circuit 330 having the constitution will be described below with reference to the operation when error diffusion processing pixel data ED corresponding to a pixel G(j, k) of the PDP 10 as shown in FIG. 10 is found.

Firstly, for error data corresponding to a pixel G(j, k−1) on the left side of the pixel G(j, k), a pixel G(j−1, k−1) diagonal up to the left of the pixel G(j, k), a pixel G(j−1, k) just above the pixel G(j, k), and a pixel G(j−1, k+1) diagonal up to the right of the pixel G(j, k), that is, for the following error data: error data corresponding to pixel G (j, k−1): delay added signal AD₁; error data corresponding to pixel G (j−1, k+1): delay added signal AD₃; error data corresponding to pixel G (j−1, k): delay added signal AD₄; and error data corresponding to pixel G (j−1, k−1): delay added signal AD₅, weight addition is executed using the coefficient values K₁ to K₄. Next, the lower 2 bit data in the first conversion pixel data D_{H}, that is, the error data corresponding to the pixel G (j, k) is added to this addition result. Next, 7-bit error diffusion processing pixel data ED is obtained by adding a 1-bit carry out signal Cₒ as this addition result to the upper 7-bit data in the first conversion pixel data D_{H}, that is, the display data corresponding to the pixel G(j, k).

Namely, the error diffusion processing circuit 330 executes the weight addition for the error data in each of the pixels G (j, k−1), G (j−1, k+1), G (j−1, k), and G (j−1, k−1) around the pixel G (j, k), and reflects its addition result in the display data corresponding to the pixel G (j, k). By the operation, the luminance component corresponding to the lower 2-bit data in the pixel G (j, k) is represented in a pseudo manner by the above surrounding pixels. Therefore, by the display data of the bit number than is smaller than 8 bits, that is, the display data of 7-bits, the luminance gradation equivalent to that of the 8-bit pixel data D can be represented. In the case that the coefficient value of this error diffusion is added to each pixel in a fixed manner, there is a case where noise due to the error diffusion pattern can be visually confirmed, so that image quality is damaged. Therefore, the error diffusion coefficient K₁ to K₄ to be assigned to each of the four pixels may be changed for each field (frame).

The dither processing circuit 350 provides dither processing as described below for the error diffusion processing pixel data ED supplied from the error diffusion processing circuit 330. Hereby, the dither processing circuit 350 generates multi gradation processing pixel data D_{S} in which the bit number is reduced to 4-bits while the luminance gradation level equivalent to the halftone luminance represented by the 7-bit error diffusion processing pixel data ED is kept. Also in the dither processing, one halftone luminance is represented by a plurality of pixels which are adjacent to each other.

FIG. 11 is a diagram showing the inner constitution of the dither processing circuit 350. The dither processing circuit comprises a movement detecting circuit 351, a dither table memory 352, a reading circuit 353, an adder 354, and a upper bit extracting circuit 355. The movement detecting circuit 351 generates a movement vector signal for each pixel group in accordance with the error diffusion processing pixel data ED. A movement vector detecting method has been disclosed in, for example, JP-A-7-59089. The dither table memory 352 is a dither matrix circuit which stores 3-bit dither values capable of representing “0” to “7” for each pixel of a pixel group comprising 4 rows×4 columns. Further, the dither table memory 352 includes a static image dither table and a dynamic image dither table which indicate dither values of sequential four frames (or four fields) of the pixel group.

The reading circuit 353 reads a dither value from either of the static image dither table and the dynamic image dither table in accordance with the movement direction and the moving amount indicated by the movement vector signal from the movement detecting circuit 351 to supply the dither value to the adder 354. Namely, in the case that the movement amount indicated by the vector signal for each pixel group is a threshold or less, the reading circuit 353 judges its data as a static image and reads a dither value from the static image dither table. In the case that the movement amount is larger than the threshold, the reading circuit 353 judges its image as a dynamic image and reads a dither value from the dynamic image dither table. In the case of reading from the dynamic image dither table, a reading start position is shifted according the movement direction indicated by the movement vector signal, and its shift amount is determined by the movement amount.

The adder 354 adds the dither value represented by 3 bits, which is supplied from the reading circuit 353, to the lower 3-bit data of the error diffusion processing pixel data ED. The adder 354 supplies this addition result as dither addition pixel data to the upper bit extracting circuit 355. The upper bit extracting circuit 355 extracts the upper 4-bit data from the dither addition pixel data, and outputs this extracted data as multi gradation pixel data D_{S}.

The pixel group is basically composed of a portion of four rows×four columns in pixels G_{(1, 1)} to G_{(n, m)} of the PDP 10, which is surrounded by thick lines.

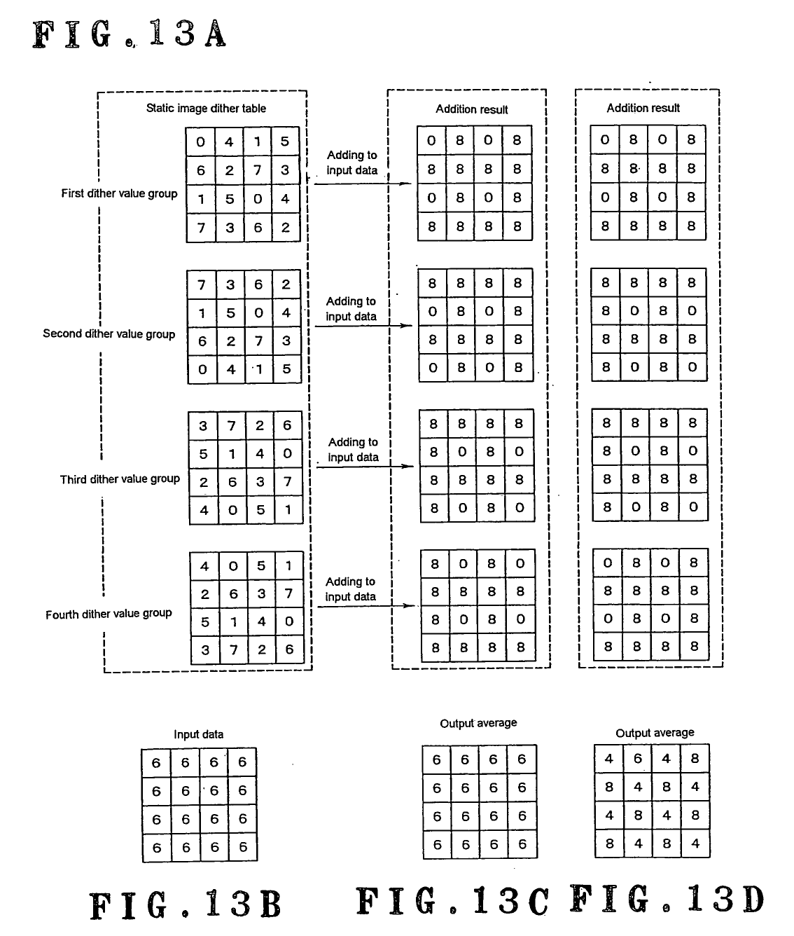

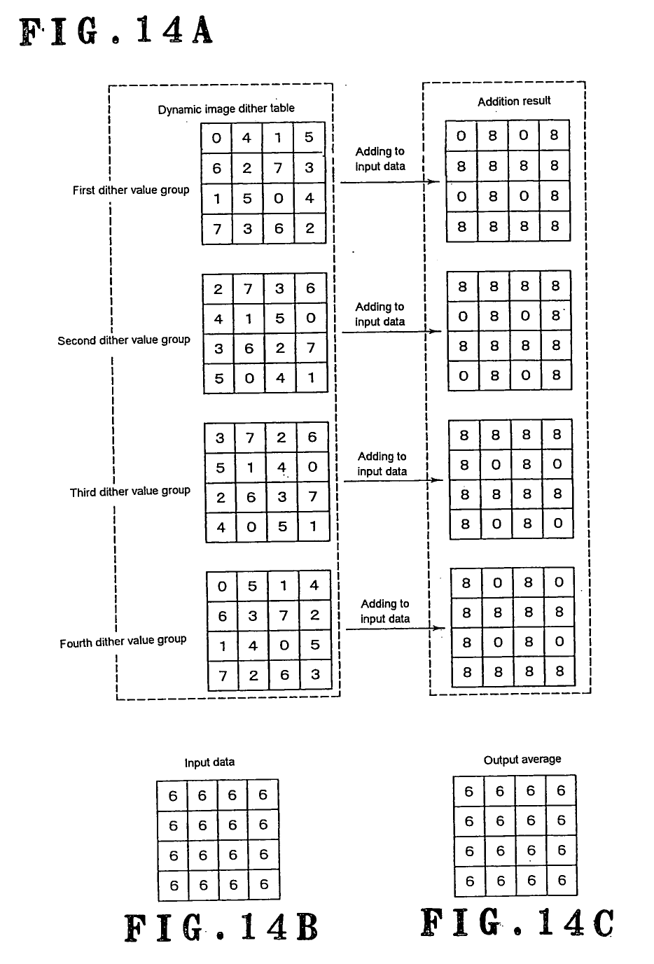

A left portion of FIG. 13A shows each dither value of the first to fourth dither value groups in the static image dither table correspondingly to the pixel position. A left portion of FIG. 14A shows each dither value of the first to fourth dither value groups in the dynamic image dither table correspondingly to the pixel position.

With reference to the dither values of the dither tables shown in FIGS. 13A and 14A, the operations of the reading circuit 353 and the adder 354 will be specifically described below. Herein, a case in which the first to fourth dither value groups of each dither table correspond to the sequential 4 fields A to D of the video signals in time association will be described. Further, each field and the row are judged in accordance with a vertical synchronization signal V and a horizontal synchronization signal H, and the column is judged in accordance with a clock signal.

In the case that the reading circuit 353 judges the pixel group portion as a static image because the movement amount indicated by the movement vector signal output from the movement detecting circuit 351 is the threshold or less, the reading circuit 353 reads a dither value from the static image dither table.

Specifically, the reading circuit 353, in a first field A, correspondingly to the respective pixels belonging to the (4L-3)-th column, the (4L-2)-th column, the (4L-1)-th column, and the 4L-the column in the (4K-3)-th row of the PDP 10, reads dither values of “0”, “4”, “1”, and “5” of the first row in the first dither value group in the static image dither table in that order. The reading circuit 353, correspondingly to the respective pixels belonging to the (4L-3)-th column, the (4L-2)-th column, the (4L-1)-th column, and the 4L-the column in the (4K-2)-th row of the PDP 10, reads dither values of “6”, “2”, “7”, and “3” of the second row in the first dither value group in the static image dither table in that order. The reading circuit 353, correspondingly to the respective pixels belonging to the (4L-3)-th column, the (4L-2)-th column, the (4L-1)-th column, and the 4L-the column in the (4K-1)-th row of the PDP 10, reads dither values of “1”, “5”, “0”, and “4” of the third row in the first dither value group in the static image dither table in that order. Further, the reading circuit 353, correspondingly to the respective pixels belonging to the (4L-3)-th column, the (4L-2)-th column, the (4L-1)-th column, and the 4L-the column in the (4K)-th row of the PDP 10, reads dither values of “7”, “3”, “6”, and “2” of the fourth row in the first dither value group in the static image dither table in that order.

The above K is a natural number of 1 to n/4, and the above L is a natural number of 1 to m/4.

In the next field B, the reading circuit 353, correspondingly to the respective pixels belonging to the (4L-3)-th column, the (4L-2)-th column, the (4L-1)-th column, and the 4L -the column in the (4K-3)-th row of the PDP 10, reads dither values of “7”, “3”, “6”, and “2” of the first row in the second dither value group in the static image dither table in that order. Further, the reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “1”, “5”, “0”, and “4” of the second row in the second dither value group in the static image-dither table in that order. The reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “6”, “2”, “7”, and “3” of the third row in the second dither value group in the static image dither table in that order. Further, the reading circuit 353, correspondingly to the respective pixels belonging to the (4L-3)-th column, the (4L -2)-th column, the (4L -1)-th column, and the 4L -the column in the (4K)-th row of the PDP 10, reads dither values of “6”, “2”, “7”, and “3” of the fourth row in the second dither value group in the static image dither table in that order.

In the next field C, the reading circuit 353, correspondingly to the respective pixels belonging to the (4L-3)-th column, the (4L -2)-th column, the (4L -1)-th column, and the 4L -the column in the (4K-3)-th row of the PDP 10, reads dither values of “3”, “7”, “2”, and “6” of the first row in the third dither value group in the static image dither table in that order. Further, the reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “5”, “1”, “4”, and “0” of the second row in the third dither value group in the static image dither table in that order. The reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “2”, “6”, “3”, and “7” of the third row in the third dither value group in the static image dither table in that order. Further, the reading circuit 353, correspondingly to the respective pixels belonging to the (4L-3)-th column, the (4L -2)-th column, the (4L -1)-th column, and the 4L -the column in the (4K)-th row of the PDP 10, reads dither values of “4”, “0”, “5”, and “1” of the fourth row in the third dither value group in the static image dither table in that order.

In the next field D, the reading circuit 353, correspondingly to the respective pixels belonging to the (4L-3)-th column, the (4L -2)-th column, the (4L -1)-th column, and the 4L -the column in the (4K-3)-th row of the PDP 10, reads dither values of “4”, “0”, “5”, and “1” of the first row in the fourth dither value group in the static image dither table in that order. Further, the reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “2”, “6”, “3”, and “7” of the second row in the fourth dither value group in the static image dither table in that order. In this field B, the reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “5”, “1”, “4”, and “0” of the third row in the fourth dither value group in the static image dither table in that order. Further, the reading circuit 353, correspondingly to the respective pixels belonging to the (4L-3)-th column, the (4L -2)-th column, the (4L -1)-th column, and the 4L -the column in the (4K)-th row of the PDP 10, reads dither values of “3”, “7”, “2”, and “6” of the fourth row in the fourth dither value group in the static image dither table in that order.

On the other hand, in the case that reading circuit 353 judges its pixel group portion as a dynamic image because the movement amount indicated by the movement vector signal output from the movement detecting circuit 351 is larger than the threshold, the reading circuit 353 reads a dither value from the dynamic image dither table. Further, the reading circuit 353, correspondingly to the movement direction indicated by its movement vector signal, moves the reading start position in its direction in the four rows×the four columns in each of the first dither value group to the four dither value group. In the case that the movement direction is, for example, a right direction on the screen, reading is performed by the reading circuit 353 as follows.

The reading circuit 353, in a first field A, reads the dither values of each row in the first dither value group in the dynamic dither table in order of the first column, the second column, the third column, and the fourth column. Namely, the reading circuit 353, in the field A, correspondingly to the respective pixels belonging to the (4L-3)-th column, the (4L -2)-th column, the (4L -1)-th column, and the 4L -the column in the (4K-3)-th row of the PDP 10, reads dither values of “0”, “4”, “1”, and “5” of the first row in the first dither value group in the dynamic image dither table in that order. The reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “6”, “2”, “7”, and “3” of the second row in the first dither value group in the dynamic image dither table in that order. The reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “1”, “5”, “0”, and “4” of the third row in the first dither value group in the dynamic image dither table in that order. Further, the reading circuit 353, correspondingly to the respective pixels belonging to the (4L-3)-th column, the (4L -2)-th column, the (4L -1)-th column, and the 4L -the column in the (4K)-th row of the PDP 10, reads dither values of “7”, “3”, “6”, and “2” of the fourth row in the first dither value group in the dynamic image dither table in that order.

The reading circuit 353, in the next field B, reads the dither values of each row in the second dither value group in the dynamic dither table in order of the second column, the third column, the fourth column, and the first column. Namely, the reading circuit 353, in the field B, correspondingly to the respective pixels belonging to the (4L-3)-th column, the (4L -2)-th column, the (4L -1)-th column, and the 4L -the column in the (4K-3)-th row of the PDP 10, reads dither values of “7”, “3”, “6”, and “2” of the first row in the second dither value group in the dynamic image dither table in that order. Further, the reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “1”, “5”, “0”, and “4” of the second row in the second dither value group in the dynamic image dither table in that order. The reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “6”, “2”, “7”, and “3” of the third row in the second dither value group in the dynamic image dither table in that order. Further, the reading circuit 353, correspondingly to the respective pixels belonging to the (4L-3)-th column, the (4L -2)-th column, the (4L -1)-th column, and the 4L -the column in the (4K)-th row of the PDP 10, reads dither values of “0”, “4”, “1”, and “5” of the fourth row in the second dither value group in the dynamic image dither table in that order.

The reading circuit 353, in the next field C, reads the dither values of each row in the third dither value group in the dynamic dither table in order of, the third column, the fourth column, the first column, and the second column. Namely, the reading circuit 353, in the field C, correspondingly to the respective pixels belonging to the (4L-3)-th column, the (4L -2)-th column, the (4L -1)-th column, and the 4L -the column in the (4K-3)-th row of the PDP 10, reads dither values of “2”, “6”, “3”, and “7” of the first row in the third dither value group in the dynamic image dither table in that order. Further, the reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “4”, “0”, “5”, and “1” of the second row in the third dither value group in the dynamic image dither table in that order. The reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “3”, “7”, “2”, and “6” of the third row in the third dither value group in the dynamic image dither table in that order. Further, the reading circuit 353, correspondingly to the respective pixels belonging to the (4L-3)-th column, the (4L -2)-th column, the (4L -1)-th column, and the 4L -the column in the (4K)-th row of the PDP 10, reads dither values of “5”, “1”, “4”, and “0” of the fourth row in the third dither value group in the dynamic image dither table in that order.

The reading circuit 353, in the next field D, reads the dither values of each row in the fourth dither value group in the dynamic dither table in order of the fourth column, the first column, the second column, and the third column. Namely, the reading circuit 353, in the field D, correspondingly to the respective pixels belonging to the (4L-3)-th column, the (4L -2)-th column, the (4L -1)-th column, and the 4L -the column in the (4K-3)-th row of the PDP 10, reads dither values of “4”, “0”, “5”, and “1” of the first row in the fourth dither value group in the dynamic image dither table in that order. Further, the reading circuit 353, correspondingly to the respective pixels belonging to the (4L-3)-th column, the (4L -2)-th column, the (4L -1)-th column, and the 4L -the column in the (4K-2)-th row of the PDP 10, reads dither values of “2”, “6”, “3”, and “7” of the second row in the fourth dither value group in the dynamic image dither table in that order. In this field B, the reading circuit 353, correspondingly to the respective pixels belonging to the (4L-3)-th column, the (4L -2)-th column, the (4L -1)-th column, and the 4L -the column in the (4K-1)-th row of the PDP 10, reads dither values of “5”, “1”, “4”, and “0” of the third row in the fourth dither value group in the dynamic image dither table in that order. Further, the reading circuit 353, correspondingly to the respective pixels belonging to the (4L-3)-th column, the (4L -2)-th column, the (4L -1)-th column, and the 4L-the column in the (4K)-th row of the PDP 10, reads dither values of “3”, “7”, “2”, and “6” of the fourth row in the fourth dither value group in the dynamic image dither table in that order.

Regarding the lower 3-bit data of the error diffusion processing pixel data ED, which is input data of the adder 354, in the case that all the pixels of 4 rows×4 columns represent “6” as shown in FIGS. 3B and 14B, the addition results by the adder 354 for the first to the fourth dither value groups in each of the static image dither table and the dynamic image dither table are shown respectively in FIGS. 13A and 14A. In FIGS. 13A and 14A, in the addition results by the adder 354, the pixels carried to the fourth digit bit from down are presented by “8”, and the not-carried pixels are represented by “0”. Regarding the average output in the case of the static image, as shown in FIG. 13C, all the pixels of 4 rows×4 columns represent “6”. Further, also regarding the average output in the case of the dynamic image, as shown in FIG. 14C, all the pixels of 4 rows×4 columns represent “6”. These average outputs are the same as the output of the lower 3-bit data of the pixel data ED.

Further, in the dynamic image, in the case that the dither value is read from the static image dither table similarly to reading from the dynamic image dither table, the addition results by the adder 354 for the first to the fourth dither value groups become as shown in a right portion of FIG. 13A. Regarding its average output, as shown in FIG. 13D, all the pixels of 4 rows×4 columns do not represent “6”.

Since the upper bit extracting circuit 355 extracts the upper 4-bit data from the pixel data of the addition result by the adder 354, its carry is reflected in the output data D_{S} of the upper bit extracting circuit 355.

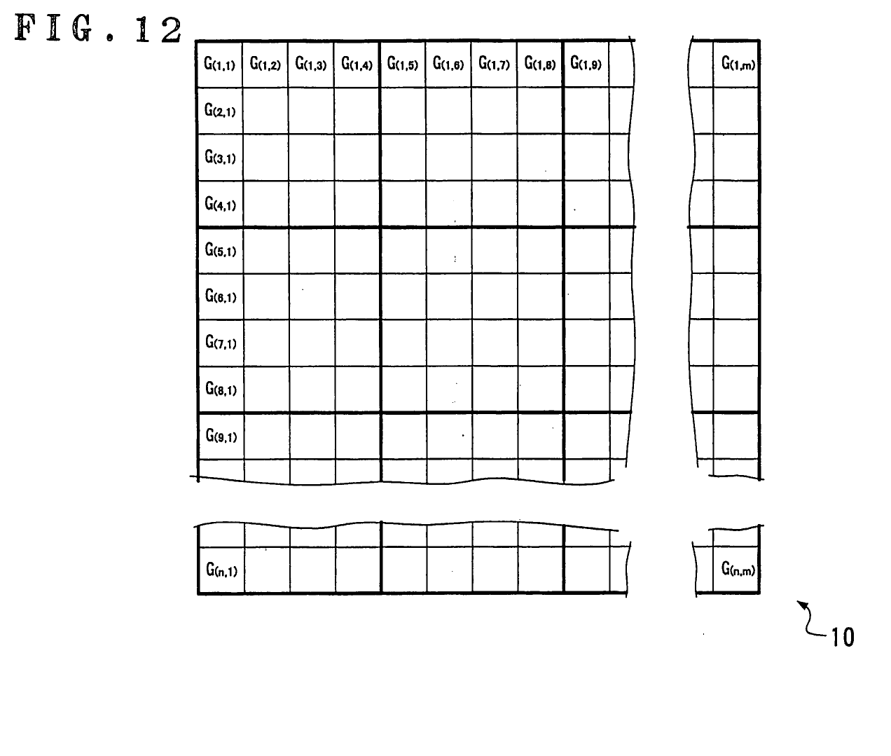

As described above, in this dither processing circuit 350, dither processing is performed with a pixel group of 4 rows×4 columns surrounded by thick lines in FIG. 12 taken as one display unit. Namely, to the lower 3-bit data of each of the error diffusion processing pixel data ED corresponding to 16 pixels in the pixel group of 4 rows×4 columns, the dither values of “0” to “7” represented by the 3 bits are assigned as shown in FIGS. 13A and 14A, and added. When the dither values of “0” to “7” represented by the 3 bits are thus added to the lower 3-bit data of each of the error diffusion processing pixel data ED corresponding to 16 pixels, any of the following eight carry states occurs:
1) case in which carry is produced in only the pixel to which the dither value “7” is added;
2) case in which carry is produced in the pixels to which the dither values “6” and “7” are respectively added;
3) case in which carry is produced in the pixels to which the dither values “5” to “7” are respectively added;
4) case in which carry is produced in the pixels to which the dither values “4” to “7” are respectively added;
5) case in which carry is produced in the pixels to which the dither values “3” to “7” are respectively added;
6) case in which carry is produced in the pixels to which the dither values “2” to “7” are respectively added;
7) case in which carry is produced in the pixels to which the dither values “1” to “7” are respectively added; and
8) case in which carry is not produced in all the pixels.
   Therefore, in the case that the pixel group of 4 rows×4 columns is taken as one display unit, as the luminance represented by the upper 4-bit data in the above dither addition pixel data, eight kinds of combination are produced. Namely, even if the bit number of the multi gradation processing pixel data D_{S} obtained by the upper bit extracting circuit 355 is 4 bits, halftone display having representable luminance gray scale of eight times, that is, halftone display corresponding to 7 bits is possible.

In the above embodiment, only the case where the movement direction is the right direction on the screen has been described. However, in the case that the movement direction is a left direction on the screen, the reading circuit 353, in the first field A, reads data of each row in the first dither value group in the dynamic image dither table in order of the first column, the second column, the third column, and the fourth column; in the field B, reads data of each row in the second dither value group in the dynamic image dither table in order of the fourth column, the first column, the second column, and the third column; in the field C, reads data of each row in the third dither value group in the dynamic image dither table in order of the third column, the fourth column, the first column, and the second column; and in the field D, reads data of each row in the fourth dither value group in the dynamic image dither table in order of the second column, the third column, the fourth column, and the first column.

In the case that the movement direction is a upper direction on the screen, the reading circuit 353, in the first field A, reads the dither values of each row in the first dither value group in the dynamic image dither table in order of the first row to the fourth row and in order of the first column to the fourth column; in the field B, reads the dither values of each row in the second dither value group in the dynamic image dither table in order of the fourth row, the first row, the second row and the third row and in order of the first column to the fourth column; in the field C, reads the dither values of each row in the third dither value group in the dynamic image dither table in order of the third row, the fourth row, the first row, and the second row and in order of the first column to the fourth column; and in the field D, reads the dither values of each row in the fourth dither value group in the dynamic image dither table in order of the second row, the third row, the fourth row and the first row and in order of the first column to the fourth column.

In the case that the movement direction is a lower direction on the screen, the reading circuit 353, in the first field A, reads the dither values of each row in the first dither value group in the dynamic image dither table in order of the first row to the fourth row and in order of the first column to the fourth column; in the field B, reads the dither values of each row in the second dither value group in the dynamic image dither table in order of the second row, the third row, the fourth row and the first row and in order of the first column to the fourth column; in the field C, reads the dither values of each row in the third dither value group in the dynamic image dither table in order of the third row, the fourth row, the first row, and the second row and in order of the first column to the fourth column; and in the field D, reads the dither values of each row in the fourth dither value group in the dynamic image dither table in order of the fourth row, the first row, and the second row and the third row and in order of the first column to the fourth column.

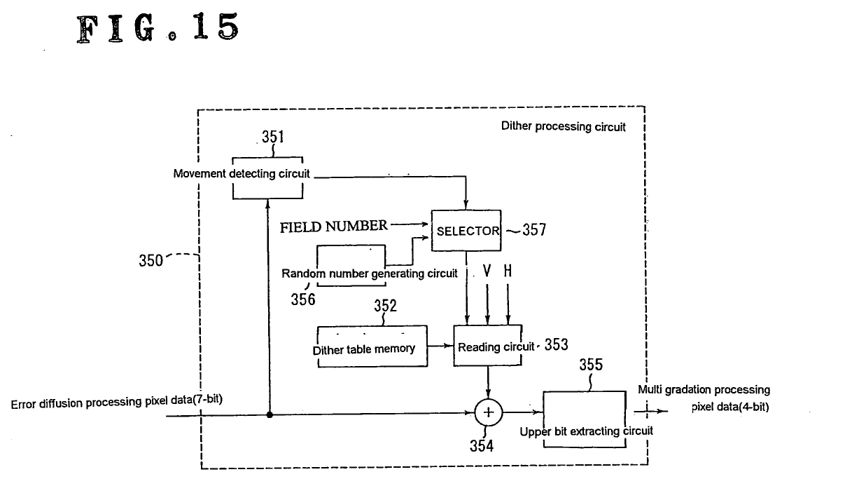

FIG. 15 shows another constitutional example of the dither processing circuit 350. The dither processing circuit 350 in FIG. 15 includes a random number generating circuit 356 and a selector 357 in addition to the movement detecting circuit 351, the dither table memory 352, the reading circuit 353, the adder 354, and the upper bit extracting circuit 355 shown in FIG. 11. The random number generating circuit 356 outputs data indicating any of integers of 1 to 4 in a random order for each field. Namely, the output values of the random number generating circuit 356 are values in which an output order of 1 to 4 changes every four fields. The selector 357 judges, in accordance with the movement detecting signal from the movement detecting circuit 351, whether an image is a static image or a dynamic image and switches the field number and the output value of the random number generating circuit 356 in accordance with the judgment result to output the switched value to the reading circuit 353. The field number supplied to the selector 357 is data in which any integer of 1 to 4 is indicated in number order of each field and repeated every four fields. The selector 357, when judges an image as a static image in accordance with the movement detection signal from the movement detecting circuit 351, supplies the field number to the reading circuit 353 as it is. The selector 357, when judges an image as a dynamic image in accordance with the movement detection signal from the movement detecting circuit 351, supplies the output value from the random number generating circuit 356 to the reading circuit 353.

In the dither processing circuit 350 of FIG. 15, only the static image dither table is stored in the dither table memory 352. Accordingly, the reading circuit 353 reads the dither value group of the number specified as the field number from the selector 357 to supply it to the adder 354.

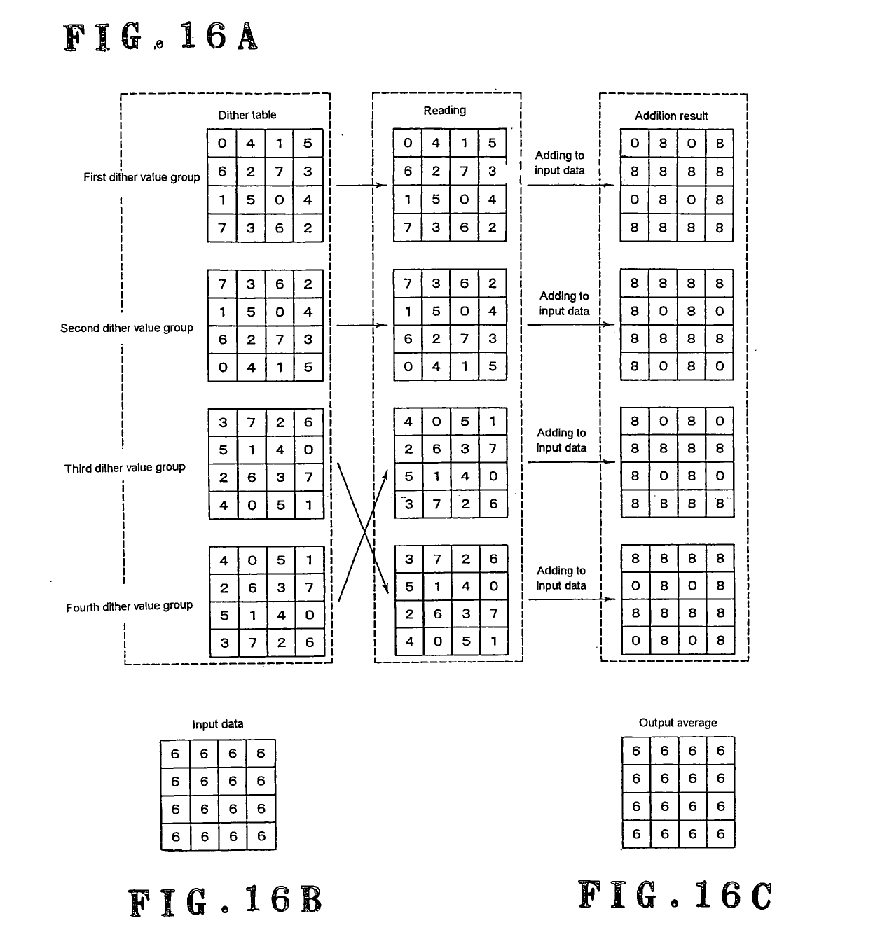

The dither table stored in the dither table memory 352 is taken as a first dither value group to the fourth dither value group as shown in FIG. 16A. This table is the same as the static image dither table shown in FIG. 13A. In the case of the static image, since the field number represents 1, 2, 3 and 4 correspondingly to the sequential four fields, its data is supplied through the selector 357 to the reading circuit 353. The reading circuit 353 reads dither values from the first dither value group to the fourth dither value group in the dither table memory 352 in that order and supplies the dither values to the adder 354. Regarding the lower 3-bit data of the error diffusion processing pixel data ED input to the adder 354, in the case that all the pixels of 4 rows×4 columns represent “6” as shown in FIG. 16B, the addition results by the adder 354 as shown in FIG. 13A are obtained. On the other hand, in the case of a dynamic image, when the output values of the random number generating circuit 356 are output correspondingly to the sequential four fields, for example, 1, 2, 4 and 3 are output in that order, their output values are supplied through the selector 357 to the reading circuit 353. Namely, as shown in a center portion of FIG. 16A, the dither values are read in order of the first dither value group, the second dither value group, the fourth dither value group and the third dither value group. Further, the reading circuit 353, correspondingly to the movement direction indicated by the movement vector signal, moves the reading start position in 4 rows×4 columns in each of the first dither value group to the fourth dither value group in that direction. Here, the movement direction is a right direction on the screen. Accordingly, the addition results by the adder 354 as shown in the right portion of FIG. 16A are obtained. Further, also regarding the average output of its addition result, as shown in FIG. 16C, all the pixel of 4 rows×4 columns become “6”.

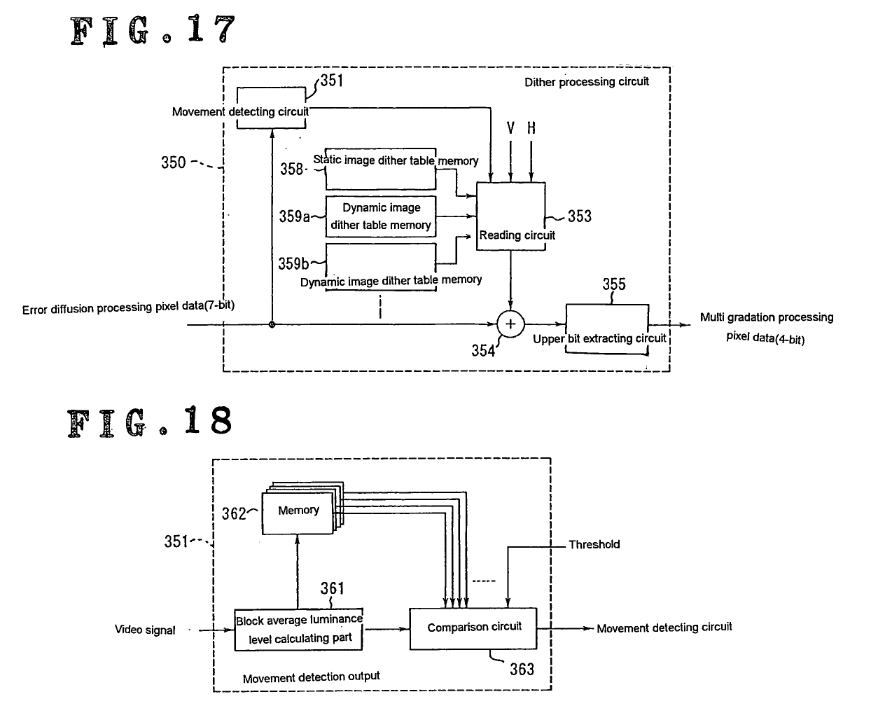

FIG. 17 shows another constitutional example of the dither processing circuit 350. The dither processing circuit 350 shown in FIG. 17 includes a static image dither table memory 358 and a plurality of dynamic image dither table memories 359a, 359b, . . . in addition to the movement detecting circuit 351, the reading circuit 353, the adder 354, and the upper bit extracting circuit 355 shown in FIG. 11. These dither table memories 358, 359a, 359b, . . . are memories which store 3-bit dither values which can represent “0” to “7” for each pixel of a pixel group comprising 4 rows×4 columns. Further, the dynamic image dither table memories 359a, 359b, . . . are provided correspondingly to difference in the movement amount of the dynamic image. Therefore, in the case of the dynamic image, the reading circuit 353 selects one dither table memory from the dynamic image dither table memories 359a, 359b, . . . in accordance with the movement amount indicated by the movement detection signal from the movement detecting circuit 351, and reads the dither value from the selected dither table memory. Other operations are similar to those in the dither processing circuit shown in FIG. 11.

FIG. 18 shows the concrete constitution of the movement detecting circuit 351 shown in FIGS. 11, 15 and 17. The movement detecting circuit 351 includes a block average luminance level calculating part 361, a memory 362, and a comparison circuit 363. The block average luminance level calculating part 361 divides the frame of the video signals supplied as the error diffusion processing pixel data ED into a plurality of blocks to calculate the average luminance level of each block. Each of these blocks is a pixel group which is larger than the pixel group of the above dither matrix. The average luminance level of each block calculated by the block average luminance level calculating part 361 is supplied to the memory 362 and the comparison circuit 363. In the memory 362, the average luminance level of each block before the number V (horizontal scanning period). The comparison circuit 363 detects a level time-variation value in accordance with the present average luminance level in the same block and the average luminance level before the number V which has been stored in the memory 362, and compares the level variation value with a threshold to judge the movement.

In the above embodiment, though the case in which the invention has been applied to the plasma display apparatus has been described, the invention can be applied also to another display apparatus such as a liquid crystal display apparatus.

Therefore, according to the invention, the dither processing circuit comprises dither value generating means which generates the dither value correspondingly to each pixel position of each pixel group on a frame, and adding means which adds the dither value to pixel data for each pixel of each pixel group to output the added result as dither processing pixel data. Since the dither value generating means changes the dither value to be generated, in accordance with the movement of the image which the video signal indicates, good dither processing by which noise in a dynamic image is suppressed can be performed.

This application is based on Japanese Patent Application No. 2004-137275 which is hereby incorporated by reference.

1. A dither processing circuit of a display apparatus for displaying a two-dimensional image on a display screen in accordance with a video signal indicative of pixel data for each pixel of a frame, comprising:
a dither value generator which generates a dither value correspondingly to each pixel position for each pixel group in said frame; and
an adder which adds the dither value to pixel data for each pixel of each pixel group to output the added result as dither processing pixel data, wherein
said dither value generator changes said dither value to be generated, in accordance with movement of an image which said video signal indicates.

2. The dither processing circuit according to claim 1, wherein said dither value generator shifts said dither value to be generated for a moving portion of said image, by a movement amount of said image.

3. The dither processing circuit according to claim 1, wherein said dither value generator comprises a memory which stores a static image dither table for generating a plurality of dither values different from each other as a static image dither value group correspondingly to each pixel position in said pixel group, and a dynamic image dither table for generating a plurality of dither values different from each other as a dynamic image dither value group correspondingly to each pixel position in said pixel group; and a reading selector which selects one of said static image dither value group and said dynamic image dither value group in accordance with the movement of the image which said video signal indicates, and supplies the one dither value group as dither values to said adder.

4. The dither processing circuit according to claim 1, wherein said dither value generator includes a dither table memory device which generates a plurality of dither values different from each other as a dither value group correspondingly to each pixel position in said pixel group; changes assignment of each of said plurality of dither values to each pixel position in said pixel group for each frame randomly, and supplies the dither values of the changed assignment to said adder.

5. The dither processing circuit according to claim 1, wherein said dither value generator changes further said dither value to be generated for each frame.

6. The dither processing circuit according to claim 1, wherein each of said pixel groups is collection of said pixels comprising N rows×M columns adjacent to each other on said frame.

7. The dither processing circuit according to claim 1, wherein said dither value generator comprises:
a first dither table memory device which generates a plurality of dither values different from each other as a first dynamic image dither value group correspondingly to each pixel position in said pixel group;
a second dither table memory device which generates a second dynamic image dither value group which is different from said first dynamic image dither value group in assignment of each of said dither values to each pixel position in said pixel group; and
a reading selector which selects one of said first dynamic image dither value group and said second dynamic image dither value group in accordance with the movement of the image which said video signal indicates, and supplies the selected one dither value group as dither values to said adder.

8. The dither processing circuit according to claim 7, wherein assignment of each of said dither values to each pixel position in said pixel group is different for each frame in each of said first dynamic image dither value group and said second dynamic image dither value group.

9. The dither processing circuit according to claim 1, wherein said dither value generator includes a movement detecting device which divides said frame into a plurality of blocks, detects an average luminance level of said video signal corresponding to each of the blocks, and detects the presence of the movement on the basis of time variation of said average luminance level in a same block.

10. The dither processing circuit according to claim 9, wherein each of the blocks is a pixel group which is larger than the pixel group to which said a plurality of dither values different from each other are assigned.
